(19) United States
(12) Patent Application Publication
(10) Pub. No.: US 2022/0009494 A1
(43) Pub. Date: Jan. 13, 2022

(54) CONTROL DEVICE, CONTROL METHOD, AND VEHICLE

(71) Applicant: HONDA MOTOR CO., LTD., Tokyo (JP)

(72) Inventors: Aditya Mahajan, Wako-shi (JP); Takayasu Kumano, Wako-shi (JP); Yuji Yasui, Wako-shi (JP)

(21) Appl. No.: 17/363,086

(22) Filed: Jun. 30, 2021

(30) Foreign Application Priority Data
Jul. 7, 2020 (JP) 2020-117307

(51) Int. Cl. B60W 30/18; G06N 20/00; B60W 60/00

(52) U.S. Cl. CPC B60W 30/18163; B60W 60/001; G06N 20/00

(57) ABSTRACT

A control device of a mobile body is provided. The control device includes at least one processor circuit with a memory comprising instructions. When executed by the processor circuit, the instructions cause the processor circuit to at least: plan an action of the mobile body; acquire an evaluation value for starting the action; and determine to start the action when the evaluation value acquired at a first time satisfies a first condition and the evaluation value acquired at a second time later than the first time satisfies a second condition. The second condition is more strict than the first condition.

### CROSS-REFERENCE TO RELATED APPLICATION(S)

This application claims priority to and the benefit of Japanese Patent Application No. 2020-117307 filed on Jul. 7, 2020, the entire disclosure of which is incorporated herein by reference.

### BACKGROUND OF THE INVENTION

### Field of the Invention

The present disclosure relates to a control device, a control method, and a vehicle.

### Description of the Related Art

Automated driving vehicles have been put into practical use. In the automated driving vehicle, a control device itself of the vehicle determines whether or not to execute a specific action. Japanese Patent Laid-Open No. 2016-009201 describes a technique for determining whether the following vehicle speed of the following vehicle is equal to or greater than a set threshold and then determining whether the following vehicle speed is equal to or greater than a larger threshold as a determination to cancel a lane change of a driving assistance device.

### SUMMARY OF THE INVENTION

It is conceivable to use an evaluation function obtained by reinforcement learning in order to determine a timing to start an action of a mobile body such as a vehicle. It is not always possible to start an action at an appropriate timing only by performing an operation whose output value of the evaluation function, that is, the evaluation value is maximum. Some aspects of the present disclosure provide a technique for determining a timing suitable for a mobile body to start a specific action.

According to some embodiments, a control device of a mobile body is provided. The control device includes at least one processor circuit with a memory comprising instructions. When executed by the processor circuit, the instructions cause the processor circuit to at least: plan an action of the mobile body; acquire an evaluation value for starting the action; and determine to start the action when the evaluation value acquired at a first time satisfies a first condition and the evaluation value acquired at a second time later than the first time satisfies a second condition. The second condition is more strict than the first condition.

### BRIEF DESCRIPTION OF THE DRAWINGS

FIG. 1 is a diagram illustrating a configuration example of a vehicle according to an embodiment of the present disclosure;

FIG. 2 is a diagram illustrating a configuration example of a control device of the vehicle according to an embodiment of the present disclosure;

FIG. 3 is a diagram illustrating an example of a control method of the vehicle according to an embodiment of the present disclosure;

FIG. 4 is a diagram illustrating an example of an action start condition according to an embodiment of the present disclosure; and

FIG. 5 is a diagram illustrating a lane change situation according to an embodiment of the present disclosure.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

An embodiment described below relates to control of a mobile body, and in particular, determination of whether or not the mobile body should start an action. In the following embodiments, a vehicle is treated as an example of the mobile body. However, the following embodiments are also applicable to mobile bodies other than vehicles, for example, ships, airplanes, drones, and the like.

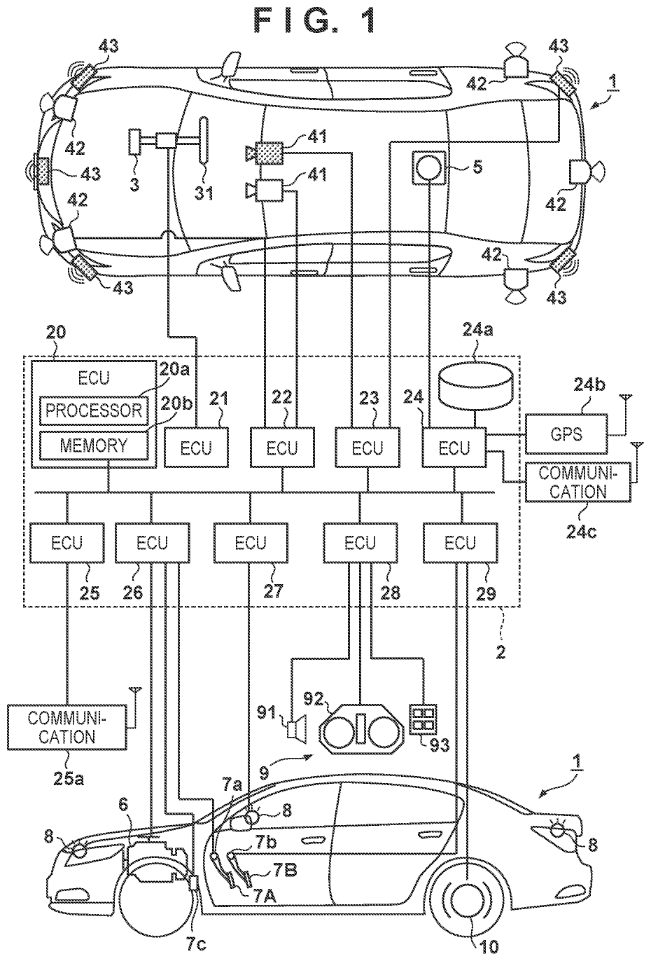

FIG. 1 is a block diagram of a vehicle 1 according to an embodiment of the present disclosure. In FIG. 1, the vehicle 1 is schematically illustrated in a plan view and a side view. The vehicle 1 is, for example, a sedan-type four-wheeled passenger vehicle. The vehicle 1 may be such a four-wheeled vehicle, a two-wheeled vehicle, or another type of vehicle.

The vehicle 1 includes a vehicle control device 2 (hereinafter, it is simply referred to as a control device 2.) that controls the vehicle 1. The control device 2 includes a plurality of electronic control units (ECUs) 20 to 29 communicably connected by an in-vehicle network. Each ECU includes a processor represented by a central processing unit (CPU), a memory such as a semiconductor memory and the like, an interface with an external device, and the like. The memory stores programs executed by the processor, data used for processing by the processor, and the like. Each ECU may include a plurality of processors, memories, interfaces, and the like. For example, the ECU 20 includes a processor 20a and a memory 20b. Processing by the ECU 20 is executed by the processor 20a executing a command included in the program stored in the memory 20b. Alternatively, the ECU 20 may include a dedicated integrated circuit such as an application-specific integrated circuit (ASIC) for executing processing by the ECU 20. The same applies to other ECUs.

Hereinafter, functions and the like assigned to each of the ECUs 20 to 29 will be described. Note that the number of ECUs and functions to be handled can be designed as appropriate and can be subdivided or integrated as compared with the present embodiment.

The ECU 20 executes control related to automated traveling of the vehicle 1. In automated driving, at least one of the steering or acceleration and deceleration of the vehicle 1 is automatically controlled. The automated traveling by the ECU 20 may include automated traveling that does not require a traveling operation by a driver (which may also be referred to as automated driving) and automated traveling for assisting the traveling operation by the driver (which may also be referred to as driving assistance).

The ECU 21 controls an electric power steering device 3. The electric power steering device 3 includes a mechanism that steers the front wheels according to the driver's driving operation (steering operation) on the steering wheel 31. In addition, the electric power steering device 3 includes a motor that exerts driving force for assisting steering operation and automatically steering the front wheels, a sensor that detects a steering angle, and the like. When the driving state of the vehicle 1 is automated driving, the ECU 21 automatically controls the electric power steering device 3 in response to an instruction from the ECU 20 and controls the traveling direction of the vehicle 1.

The ECUs 22 and 23 perform control of detection units 41 to 43 that detect the surrounding situation of the vehicle and information processing of the detection result. The detection unit 41 is a camera that captures an image of the front of the vehicle 1 (hereinafter, it may be referred to as a camera 41) and is attached to the vehicle interior side of the windshield at the front of the roof of the vehicle 1 in the present embodiment. By analyzing the image captured by the camera 41, it is possible to extract a contour of an object or extract a division line (white line or the like) of a lane on a road.

The detection unit 42 is a light detection and ranging (lidar) (hereinafter, it may be referred to as a lidar 42 and detects an object around the vehicle 1, measures a distance to the object, and the like. In the case of the present embodiment, five lidars 42 are provided, one at each corner portion of the front portion, one at the center of the rear portion, and one at each side of the rear portion of the vehicle 1. The detection unit 43 is a millimeter-wave radar (hereinafter, it may be referred to as a radar 43) and detects an object around the vehicle 1, measures a distance to the object, and the like. In the case of the present embodiment, five radars 43 are provided, one at the center of the front portion, one at each corner portion of the front portion, and one at each corner portion of the rear portion of the vehicle 1.

The ECU 22 performs control of one camera 41 and each lidar 42 and information processing of the detection result. The ECU 23 performs control of the other camera 41 and each radar 43 and information processing of the detection result. Since two sets of devices for detecting the surrounding situation of the vehicle are provided, the reliability of the detection result can be improved, and since different types of detection units such as a camera, a lidar, and a radar are provided, the surrounding environment of the vehicle can be analyzed in multiple ways.

The ECU 24 performs control of a gyro sensor 5, a global positioning system (GPS) sensor 24b, and a communication device 24c and information processing of a detection result or a communication result. The gyro sensor 5 detects a rotational motion of the vehicle 1. The course of the vehicle 1 can be determined based on the detection result of the gyro sensor 5, the wheel speed, and the like. The GPS sensor 24b detects the current position of the vehicle 1. The communication device 24c performs wireless communication with a server that provides map information and traffic information and acquires these pieces of information. The ECU 24 can access a database 24a of map information constructed in the memory, and the ECU 24 searches for a route from the current position to a destination and the like. The ECU 24, the map database 24a, and the GPS sensor 24b constitute a so-called navigation device.

The ECU 25 is provided with a communication device 25a for inter-vehicle communication. The communication device 25a performs wireless communication with other surrounding vehicles to exchange information between the vehicles.

The ECU 26 controls a power plant 6. The power plant 6 is a mechanism that outputs driving force for rotating driving wheels of the vehicle 1 and includes, for example, an engine and a transmission. For example, the ECU 26 controls the output of the engine according to the driving operation (accelerator operation or acceleration operation) of the driver detected by an operation detection sensor 7a provided on an accelerator pedal 7A and switches the gear ratio of the transmission based on information such as the vehicle speed detected by the vehicle speed sensor 7c and the like. When the driving state of the vehicle 1 is automated driving, the ECU 26 automatically controls the power plant 6 in response to an instruction from the ECU 20 and controls the acceleration and deceleration of the vehicle 1.

The ECU 27 controls a light device (headlight, taillight, and the like) including a direction indicator 8 (blinker). In the example of FIG. 1, the direction indicators 8 are provided at the front portion, the door mirror, and the rear portion of the vehicle 1.

The ECU 28 controls an input/output device 9. The input/output device 9 outputs information to the driver and accepts an input of information from the driver. A voice output device 91 notifies the driver of information by voice. A display device 92 notifies the driver of information by displaying an image. The display device 92 is arranged, for example, in front of the driver's seat and constitutes an instrument panel or the like. Note that, although the voice and the display have been exemplified here, information may be notified by vibrations or light. In addition, information may be notified by a combination of some of the voice, display, vibrations, and light. Furthermore, the combination or the notification form may be changed in accordance with the level (for example, the degree of urgency) of information that should be notified. An input device 93 is a switch group that is arranged at a position where the driver can operate it and is used to input an instruction to the vehicle 1. The input device 93 may also include a voice input device.

The ECU 29 controls a brake device 10 and a parking brake (not illustrated in the drawings). The brake device 10 is, for example, a disc brake device, and is provided on each wheel of the vehicle 1 to decelerate or stop the vehicle 1 by applying resistance to the rotation of the wheel. The ECU 29 controls the operation of the brake device 10 in response to the driver's driving operation (brake operation) detected by an operation detection sensor 7b provided on a brake pedal 7B, for example. When the driving state of the vehicle 1 is automated driving, the ECU 29 automatically controls the brake device 10 in response to an instruction from the ECU 20 and controls the deceleration and stop of the vehicle 1. The brake device 10 and the parking brake can also operate to maintain a stopped state of the vehicle 1. In addition, when the transmission of the power plant 6 includes a parking lock mechanism, it can also be operated to maintain the stopped state of the vehicle 1.

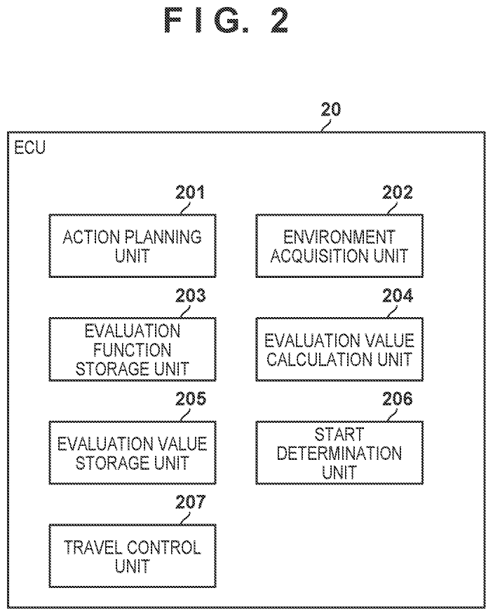

An example of functional blocks of the ECU 20 will be described with reference to FIG. 2. In FIG. 2, functions related to the automated driving among functions of the ECU 20 will be described. The ECU 20 includes an action planning unit 201, an environment acquisition unit 202, an evaluation function storage unit 203, an evaluation value calculation unit 204, an evaluation value storage unit 205, a start determination unit 206, and a travel control unit 207. The action planning unit 201, the environment acquisition unit 202, the evaluation value calculation unit 204, the start determination unit 206, and the travel control unit 207 may be realized by the processor 20a. Specifically, the operation of these functional units may be performed by the processor 20a executing a program stored in the memory 20b. Alternatively, some or all of these functional units may be realized by a dedicated circuit such as an application-specific integrated circuit (ASIC) or a field-programmable gate array (FPGA). The evaluation function storage unit 203 and the evaluation value storage unit 205 may be realized by the memory 20b.

The action planning unit 201 plans an action of the vehicle 1. The action planned by the action planning unit 201 may be any action related to the vehicle 1, such as lane change, right turn, left turn, automatic braking, automatic parking, and the like. The action planning unit 201 may plan an action based on an instruction from the driver or may plan an action in accordance with a travel plan (for example, a route to a destination).

The environment acquisition unit 202 acquires information regarding the travel environment of the vehicle 1. The information regarding the travel environment of the vehicle 1 may include information on the vehicle 1 and information on the surroundings of the vehicle 1. The information regarding the vehicle 1 may include dynamic information (current speed, current acceleration, current geographical position, and the like) and static information (vehicle length, vehicle width, weight, and the like of the vehicle 1). The information regarding the vehicle 1 may be acquired based on an output from a sensor installed in each actuator of the vehicle 1. The information on the surroundings of the vehicle 1 may include information regarding a dynamic object (for example, other vehicles, pedestrian, and the like) existing around the vehicle 1 and a static object (for example, a road, a traffic light, a traffic sign, and the like) existing around the vehicle 1. The information regarding the surrounding vehicles may include a relative relationship (relative position, relative speed, relative acceleration, and the like) between the individual vehicles and the vehicle 1. The information regarding the surroundings may be acquired based on the output from the detection units 41 to 43 of the vehicle 1.

The evaluation function storage unit 203 stores an evaluation function for calculating an evaluation value for the action of the vehicle 1. Specifically, the evaluation function outputs an evaluation value for the action using the current travel environment regarding the vehicle 1 and the action of the vehicle in the travel environment as arguments. The higher the evaluation value, the more likely it is that a particular action will succeed. For example, in a case where the vehicle 1 performs a lane change, it is more likely that the lane change is successful when the lane change is started at a time when the evaluation value is high than when the lane change is started at a time when the evaluation value is low.

The evaluation function may be generated by reinforcement learning in advance and stored in the evaluation function storage unit 203. The evaluation function may be stored in the evaluation function storage unit 203 at the time of manufacturing the vehicle 1, or may be stored in the evaluation function storage unit 203 after the vehicle 1 is sold. Further, the evaluation function stored in the evaluation function storage unit 203 may be updated via a communication network.

The evaluation function is generated, for example, by performing reinforcement learning. As reinforcement learning, Q-learning may be used. Further, reinforcement learning may utilize ensemble learning, for example, random forest. As an environment in reinforcement learning, information of a type that can be acquired by the environment acquisition unit 202 may be used. These environments may be generated by simulation.

The evaluation value calculation unit 204 uses the evaluation function stored in the evaluation function storage unit 203 to calculate an evaluation value for each of starting and not starting (waiting) the action determined by the action planning unit 201 with respect to the vehicle environment acquired by the environment acquisition unit 202. The evaluation value calculation unit 204 stores the calculated evaluation value in the evaluation value storage unit 205. In this embodiment, the evaluation value calculation unit 204 calculates the evaluation value. Alternatively, the ECU 20 may acquire the evaluation value by transmitting information regarding the vehicle environment to an external server and receiving the evaluation value from the external server. In this case, the evaluation function storage unit 203 may be omitted.

The start determination unit 206 determines whether or not to start the action determined in the action planning unit 201 based on the evaluation value. The travel control unit 207 controls the operation of each actuator of the vehicle 1 in order to realize the action determined by the start determination unit 206 to start. Specifically, the travel control unit 207 controls at least one of steering or the acceleration and deceleration of the vehicle 1. For example, when it is determined to start a lane change, the travel control unit 207 moves to the adjacent lane by controlling both steering and the acceleration and deceleration of the vehicle 1.

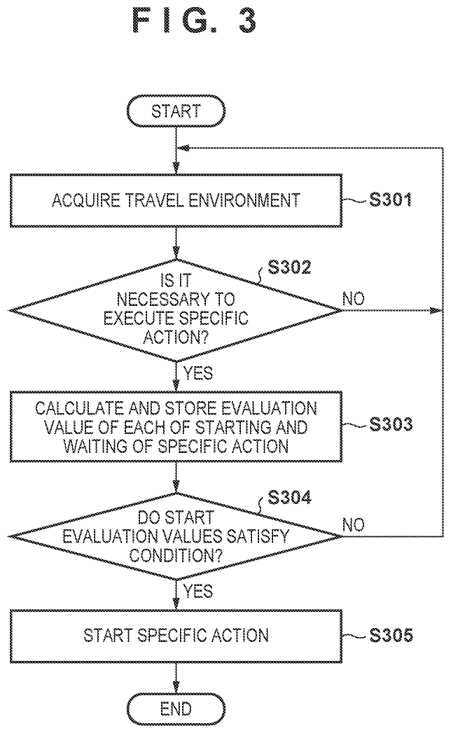

An example of a control method performed by the ECU 20, specifically, a functional unit thereof will be described with reference to FIG. 3. This method may be started in response to the start of the automated driving of the vehicle 1. This method may be repeatedly executed until the automated driving of the vehicle 1 ends.

In step S301, the environment acquisition unit 202 acquires information regarding the travel environment of vehicle 1. Specific examples of the acquired information are as described above.

In step S302, the action planning unit 201 determines whether or not it is necessary to execute a specific action. In a case where it is determined that it is necessary to execute the specific action (“YES” in step S302), the processing proceeds to step S303, and in the other case (“NO” in step S302), the processing proceeds to step S301. When proceeding to step S301, information regarding the travel environment (information after some time elapses from the previous acquisition) is acquired.

For example, the action planning unit 201 may determine that it is necessary to execute a lane change of the vehicle 1 in order to head to the destination. In this case, the lane change is planned as the specific action. In addition, the action planning unit 201 may determine that it is necessary to stop the vehicle 1 in a parking lot. In this case, execution of an automated parking function is planned as the specific action.

In step S303, the evaluation value calculation unit 204 uses an evaluation function stored in the evaluation function storage unit 203 to calculate an evaluation value for starting the specific action at the present time and an evaluation value for not starting the specific action at the present time (in other words, waiting) for the current travel environment, and stores these evaluation values in the evaluation value storage unit 205. The current travel environment is the travel environment acquired by the most recent execution of step S301. An evaluation value for starting a specific action is referred to as a start evaluation value. An evaluation value for not starting a specific action at the current time (in other words, waiting) is referred to as a wait evaluation value.

In step S304, the start determination unit 206 determines whether or not the start evaluation values calculated at a plurality of times satisfy a predetermined condition. The predetermined condition will be described later. The start evaluation value and the wait evaluation value calculated at each time are stored in the evaluation value storage unit 205 in step S303. In a case where it is determined that the start evaluation value satisfies the predetermined condition (“YES” in step S304), the processing proceeds to step S305, and in the other case (“NO” in step S304), the processing proceeds to step S301. In step S305, the travel control unit 207 starts the specific action. Therefore, it can be said that the predetermined condition in step S304 is a condition for the vehicle 1 to start the specific action. Therefore, the predetermined condition determined in step S304 is hereinafter referred to as an action start condition.

A time when the evaluation value is calculated immediately before the execution of step S304 (that is, when step S303 was executed) is defined as T2, and a time when the evaluation value is calculated before the time T2 is defined as T1. The time T2 may be a time at which the evaluation value is acquired next to the time T1, or the evaluation value may be acquired at another time between the time T1 and the time T2. Hereinafter, it is assumed that time T1 and time T2 are continuous. The action start condition may include that the evaluation value calculated at time t=T1 satisfies a condition in the following Expression (1) (hereinafter, referred to as condition 1) and the evaluation value calculated at time t=T2 satisfies a condition in the following Expression (2) (hereinafter, referred to as condition 2).

$$\begin{matrix}Expression ( 1 ) & \\ \frac{exp ( Q ( {s}_{t} , {a}_{t} = START ) )}{\begin{matrix}exp ( Q ( {s}_{t} , {a}_{t} = START ) ) + \\ exp ( Q ( {s}_{t} , {a}_{t} = WAIT ) )\end{matrix}} > {θ}_{1} & Expression ( 1 ) \\ Expression ( 2 ) & \\ \frac{exp ( Q ( {s}_{t} , {a}_{t} = START ) )}{\begin{matrix}exp ( Q ( {s}_{t} , {a}_{t} = START ) ) + \\ exp ( Q ( {s}_{t} , {a}_{t} = WAIT ) )\end{matrix}} > {θ}_{2} & Expression ( 2 )\end{matrix}$$

Expressions (1) and (2) will be described. In the expressions, sₜ represents a travel environment at time t. Here, sₜ may be a vector value. In the expressions, aₜ represents an action at time t. A value of aₜ when starting a specific action is represented by START, and a value of aₜ when not starting the specific action (waiting) is represented by WAIT. In the expressions, Q(sₜ, aₜ) represents an evaluation value when the action aₜ is performed on the travel environment sₜ. When the reinforcement learning is Q-learning, this evaluation value may be referred to as a Q-value. The left side of Expression (1) and the left side of Expression (2) have the same value and indicate a relative value of the start evaluation value with respect to the wait evaluation value. Specifically, the left side represents a ratio of the start evaluation value to the sum of the start evaluation value and the wait evaluation value. The function for obtaining the ratio is a function called a softmax function. The relative value of the start evaluation value with respect to the wait evaluation value may be calculated using a function other than the softmax function.

In the expressions, θ₁ and θ₂ are thresholds determined in advance. Here, a condition θ₁<θ₂ is satisfied. Therefore, condition 2 is a more strict condition than condition 1. That condition 2 is more strict than condition 1 means that condition 1 is also satisfied if condition 2 is satisfied. In this manner, the start determination unit 206 determines that the action start condition is satisfied when condition 1 is satisfied at a certain time (T1) and then condition 2, which is more strict than condition 1, is satisfied at the next time (T2). When the action start condition including these two-stage conditions is satisfied, it can be said that the travel environment of the vehicle 1 has changed in a direction suitable for starting the specific action. Therefore, the start determination unit 206 can determine a timing more suitable for starting the specific action as compared with a case where a determination is made under a one-stage condition.

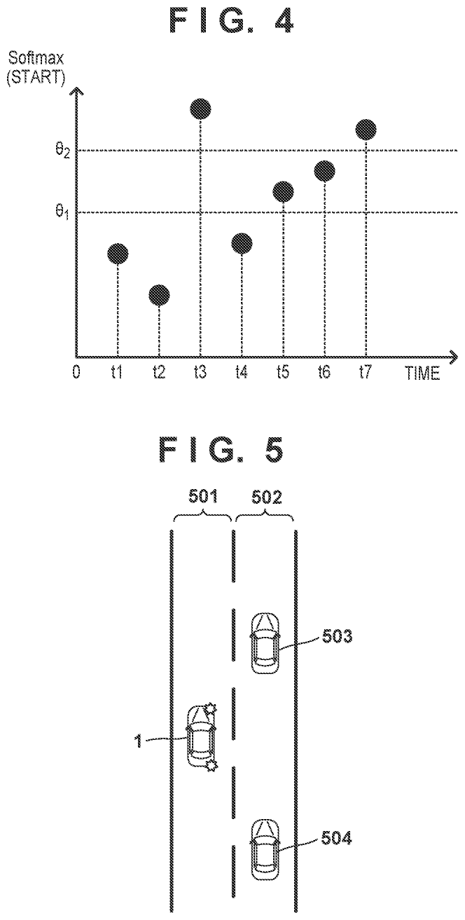

A specific example of the action start condition described above will be described with reference to FIG. 4. The horizontal axis of the graph of FIG. 4 is time, and the vertical axis is the left side of Expression (1) and the left side of Expression (2) (that is, a relative value of the start evaluation value with respect to the wait evaluation value). At times t1, t2, and t4, neither condition 1 nor condition 2 is satisfied. At times t5 and t6, condition 1 is satisfied but condition 2 is not satisfied. At times t3 and t7, both condition 1 and condition 2 are satisfied.

Condition 1 and condition 2 are satisfied at time t3, but condition 2 is not satisfied at the next time t4. Therefore, since it cannot be said that the travel environment of the vehicle 1 has changed in a direction suitable for starting a specific action, the start determination unit 206 does not determine to start the specific action. Condition 1 is satisfied at time t5, and condition 1 is satisfied but condition 2 is not satisfied at the next time t6. Therefore, since it cannot be said that the travel environment of the vehicle 1 has changed in a direction suitable for starting a specific action, the start determination unit 206 does not determine to start the specific action. Condition 1 is satisfied at time t6, and condition 2, which is more strict than condition 1, is satisfied at the next time t7. Therefore, there is a high possibility that the travel environment of the vehicle 1 has changed in a direction suitable for starting a specific action. Therefore, the start determination unit 206 determines to start the specific action.

Instead of or in addition to the conditions using Expressions 1 and 2 described above, the action start condition may include that the evaluation value calculated at time t=T1 satisfies a condition in the following Expression (3) (hereinafter, referred to as condition 3) and the evaluation value calculated at time t=T2 satisfies a condition in the following Expression (4) (hereinafter, referred to as condition 4).

[Expression 3]

Q(sₜ,aₜ=START)>θ₃ Expression (3)

[Expression 4]

Q(sₜ,aₜ=START)>θ₄ Expression (4)

In the expressions, θ₃ and θ₄ are thresholds determined in advance. Here, a condition θ₃<θ₄ is satisfied. Therefore, condition 4 is more strict than condition 3. That condition 4 is more strict than condition 3 means that condition 3 is also satisfied if condition 4 is satisfied. In this case also, the start determination unit 206 determines that the action start condition is satisfied when condition 3 is satisfied at a certain time (T1) and then condition 4, which is more strict than condition 3, is satisfied at the next time (T2). In condition 3 and condition 4, not the relative value of the start evaluation value with respect to the wait evaluation value but the start evaluation value itself is compared with the threshold.

In the above example, it is determined whether or not the action start condition is satisfied using the evaluation values at two continuous times. Alternatively, it may be determined whether or not the action start condition is satisfied using evaluation values at three or more continuous or discontinuous times. While the action start condition is not satisfied in step S304, the processing of steps S301 to S304 is repeated. In a case where the specific action is no longer required in this repetition, “NO” is selected in step S302, and the repetition of steps S303 and S304 ends. For example, in a case where the specific action is a lane change, when having passed the branch point without being able to change the lane, it is no longer required to change the lane. In this case, the action planning unit 201 plans a new action.

A use case of the control method described above will be described with reference to FIG. 5. The action planning unit 201 plans to change the lane to the adjacent lane 502 while the vehicle 1 is traveling in the lane 501. In the lane 502, a vehicle 503 is traveling in front of the vehicle 1, and a vehicle 504 is traveling behind the vehicle 1.

The environment acquisition unit 202 acquires, as the travel environment of the vehicle 1, the speed of the vehicle 1, the relative position and the relative speed of the vehicle 503 with respect to the vehicle 1, and the relative position and the relative speed of the vehicle 504 with respect to the vehicle 1. The environment acquisition unit 202 may further acquire the intention of the vehicle 503 and the vehicle 504 determined using an intelligent driver model (IDM) as the travel environment of the vehicle 1. The intentions of the vehicle 503 and the vehicle 504 may be determined from the relative accelerations of the vehicle 503 and the vehicle 504 with respect to the vehicle 1.

The evaluation value calculation unit 204 repeatedly calculates an evaluation value for starting a lane change and an evaluation value for not starting a lane change while the vehicle 1 continues traveling in the lane 501. The evaluation function used to calculate the evaluation value is a function obtained by reinforcement learning using the same type of travel environment as described above. When the calculated evaluation value satisfies the action start condition described above, the start determination unit 206 determines that the lane change should be started. In response to this determination, the travel control unit 207 starts the lane change.

### Summary of Embodiment

[Item 1]

A control device (20) of a mobile body (1), including:

a planning unit (201) that plans an action of the mobile body;

an acquisition unit (204) that acquires an evaluation value for starting the action; and

a determination unit (206) that determines to start the action when the evaluation value acquired at a first time satisfies a first condition and the evaluation value acquired at a second time later than the first time satisfies a second condition,

in which the second condition is more strict than the first condition.

According to this item, it is possible to determine a timing suitable for the mobile body to start a specific action.

[Item 2]

The control device according to item 1, in which the second time is a time at which the evaluation value is acquired next to the first time.

According to this item, it is possible to more accurately determine a timing suitable for the mobile body to start a specific action.

[Item 3]

The control device according to item 1 or 2,

in which the determination unit acquires a relative value of an evaluation value for starting the action with respect to an evaluation value for not starting the action,

the first condition includes that the relative value regarding the first time is larger than a first threshold,

the second condition includes that the relative value regarding the second time is larger than a second threshold, and

the second threshold is larger than the first threshold.

According to this item, it is possible to more accurately determine a timing suitable for the mobile body to start a specific action.

[Item 4]

The control device according to item 3, in which the relative value is calculated using a softmax function.

According to this item, it is possible to more accurately determine a timing suitable for the mobile body to start a specific action.

[Item 5]

The control device according to item 1 or 2, in which the first condition includes that an evaluation value for starting the action at the first time is larger than a third threshold,

the second condition includes that an evaluation value for starting the action at the second time is larger than a fourth threshold, and

the fourth threshold is larger than the third threshold.

According to this item, it is possible to more accurately determine a timing suitable for the mobile body to start a specific action.

[Item 6]

The control device according to any one of items 1 to 5, in which the action includes a lane change.

According to this item, it is possible to more accurately determine a timing suitable for starting the lane change.

[Item 7]

A vehicle (1) including the control device according to any one of items 1 to 6.

According to this item, a vehicle having the advantages described above is provided.

[Item 8]

A program for causing a computer to function as the control device according to any one of items 1 to 6.

According to this item, a program having the advantages described above is provided.

[Item 9]

A method for controlling a mobile body (1), the method including:

planning an action of the mobile body (S302);

acquiring an evaluation value for starting the action (S303); and

determining to start the action when the evaluation value acquired at a first time satisfies a first condition and the evaluation value acquired at a second time later than the first time satisfies a second condition (S304),

in which the second condition is more strict than the first condition.

According to this item, it is possible to determine a timing suitable for the mobile body to start a specific action.

The invention is not limited to the foregoing embodiments, and various variations/changes are possible within the spirit of the invention.

What is claimed is:

1. A control device of a mobile body, the control device comprising
at least one processor circuit with a memory comprising instructions that, when executed by the processor circuit, cause the processor circuit to at least:
plan an action of the mobile body;
acquire an evaluation value for starting the action; and
determine to start the action when the evaluation value acquired at a first time satisfies a first condition and the evaluation value acquired at a second time later than the first time satisfies a second condition,
wherein the second condition is more strict than the first condition.

2. The control device according to claim 1, wherein the second time is a time at which the evaluation value is acquired next to the first time.

3. The control device according to claim 1,
the memory further comprising instructions that, when executed by the processor circuit, cause the processor circuit to acquire a relative value of an evaluation value for starting the action with respect to an evaluation value for not starting the action,
wherein
the first condition includes that the relative value regarding the first time is larger than a first threshold,
the second condition includes that the relative value regarding the second time is larger than a second threshold, and
the second threshold is larger than the first threshold.

4. The control device according to claim 3, wherein the relative value is calculated using a softmax function.

5. The control device according to claim 1,
wherein the first condition includes that an evaluation value for starting the action at the first time is larger than a third threshold,
the second condition includes that an evaluation value for starting the action at the second time is larger than a fourth threshold, and
the fourth threshold is larger than the third threshold.

6. The control device according to claim 1, wherein the action includes a lane change.

7. A vehicle comprising the control device according to claim 1.

8. A non-transitory storage medium comprising instructions that, when executed by a processor circuit, cause the processor circuit to at least:
plan an action of a mobile body;
acquire an evaluation value for starting the action; and
determine to start the action when the evaluation value acquired at a first time satisfies a first condition and the evaluation value acquired at a second time later than the first time satisfies a second condition,
wherein the second condition is more strict than the first condition.

9. A method of controlling a mobile body, the method comprising:
planning an action of a mobile body;
acquiring an evaluation value for starting the action; and
determining to start the action when the evaluation value acquired at a first time satisfies a first condition and the evaluation value acquired at a second time later than the first time satisfies a second condition,
wherein the second condition is more strict than the first condition.
